(19) United States
(12) Patent Application Publication
(10) Pub. No.: US 2019/0097737 A1
(43) Pub. Date: Mar. 28, 2019

(54) SYSTEM, METHOD AND RELAY BASE STATION FOR TRANSMITTING DATA VIA ACOUSTIC INTERNET OF THINGS

(71) Applicant: BEIJING SOUNDBUS TECHNOLOGIES CO., LTD., Xiamen City (CN)

(72) Inventors: ZHENGYAN PENG, Xiamen City (CN); LIYU YANG, Xiamen City (CN)

(21) Appl. No.: 16/199,264

(22) Filed: Nov. 26, 2018

Related U.S. Application Data
(63) Continuation of application No. PCT/CN2017/086222, filed on May 26, 2017.

(30) Foreign Application Priority Data
May 26, 2016 (CN) 201610356075.2
Aug. 31, 2016 (CN) 201610784085.6

(51) Int. Cl. H04B 11/00; G06F 16/955; H04L 29/08

(52) U.S. Cl. CPC H04B 11/00; H04L 67/02; H04L 67/26; G06F 16/955

(57) ABSTRACT

A method for transmitting data via acoustic internet of things is provided. The method comprises following steps: sending acoustic signal containing acoustic code by an acoustic code sending device; receiving the acoustic signal by a relay base station to obtain radio signal containing the acoustic code, and sending the radio signal to a mobile terminal which is in preset range; processing the radio signal to obtain the acoustic code by the mobile terminal, and loading the acoustic code to the relay base station; obtaining a link address corresponding to the acoustic code loaded by the mobile terminal, and sending the link address to the mobile terminal; visiting a web site or entering a push-casting service platform through the link address by the mobile terminal to obtain corresponding resource information. A system and a relay base station for transmitting data via acoustic internet of things are also disclosed.

### BACKGROUND

### 1. Technical Field

The present disclosure relates to a computer technology, and particularly to a system, a method and a relay base station for transmitting data via acoustic internet of things.

### 2. Description of the Related Art

With the development of communication technology and the popularization of mobile devices, information/content providers (such as posters, books, magazines, videos) present resource information for users through URLs or QR codes converted from URLs, which are URLs for loading specific information interfaces. Users enter the URLs manually by clicking on them, or open the corresponding information content page of the information resource by scanning the QR code by the camera of the mobile device.

However, the present technology for acoustic information identification only relates decoding acoustic waves to obtain link address, and there is no acoustic-based solution for specific business models in offline application scenarios.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of a system for transmitting data via acoustic internet of things in accordance with a first exemplary embodiment.

FIG. 2 is a block diagram of a system for transmitting data via acoustic internet of things in accordance with a second exemplary embodiment.

FIG. 3 is a schematic diagram of an acoustic wave transport protocol model according to the invention.

FIG. 4 is a schematic diagram of an acoustic code data structure according to the invention.

FIG. 5 is a channel mapping table of an acoustic code information section in accordance with an exemplary embodiment.

FIG. 6 is a schematic diagram of the conversion of acoustic waves into acoustic codes loading to beacon information format in accordance with an exemplary embodiment.

FIG. 7 is a schematic diagram of data transmission information format of the acoustic Internet of things in accordance with an exemplary embodiment.

FIG. 8 is a flowchart of a method for transmitting data via acoustic internet of things in accordance with a first exemplary embodiment.

FIG. 9 is a flowchart of a method for transmitting data via acoustic internet of things in accordance with a second exemplary embodiment.

FIG. 10 is a flowchart of a method for transmitting data via acoustic internet of things in accordance with a third exemplary embodiment.

FIG. 11 is a flowchart of a method for transmitting data via acoustic internet of things in accordance with a fourth exemplary embodiment.

FIG. 12 is a flowchart of a method for transmitting data via acoustic internet of things in accordance with a fifth exemplary embodiment.

### DETAILED DESCRIPTION

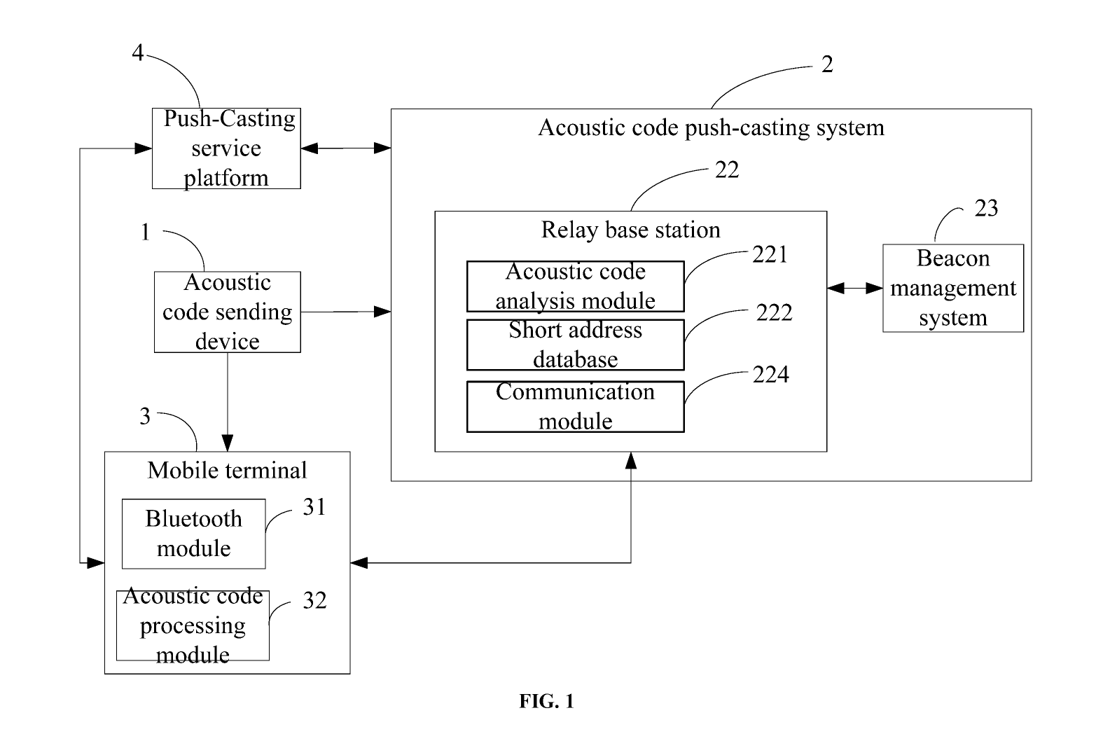

FIG. 1 shows a block diagram of a system for transmitting data via acoustic internet of things. The system 10 includes an acoustic code sending device 1, an acoustic code push-casting system 2, a mobile terminal 3, and a push-casting service platform 4.

The acoustic code sending device 1 is configured to play video/audio documents containing acoustic code. In the embodiment, the acoustic code sending device 1 is a video/audio playing device. The mobile terminal 3 includes a built-in bluetooth module 31 and an acoustic code processing module 32. The terminal mobile 3 communicates with the push-casting platform 4 via the acoustic code processing module 32.

The acoustic code push-casting system 2 includes a relay base station 22. The relay base station 22 is configured to receive an acoustic signal, process the acoustic signal to obtain radio signal containing the acoustic code, and send the radio signal to the terminal mobile 3 which is in a present range.

The acoustic code processing module 32 is configured to process the radio signal to obtain the acoustic code, and load the acoustic code to the relay base station 22. The relay base station 22 is further configured to obtain a corresponding link address according to the acoustic code uploaded by the mobile terminal 3, and send the link address to the terminal mobile 3. A relationship between acoustic codes and link addresses is pre-stored in the relay base station 22.

The acoustic code pressing module 32 is further configured to visit a web site or enter the push-casting service platform 4 through the link address to obtain the corresponding resource information when the link address is received.

In the embodiment, the relay base station 22 includes an acoustic code analysis module 221, a short address database 222, and a communication module 224. The short address database 222 is configured to pre-store the relationship between acoustic codes and link address. The communication module 224 includes a RF module and a bluetooth module which communicates with the mobile terminal 3. The acoustic code analysis module 221 is configured to obtain the corresponding link address from the short address database 222 according to the acoustic code loaded by the mobile terminal 3, and send the link address to the acoustic code processing module 32 by the communication module 224. The acoustic code pressing module 32 is further configured to visit the web site or enter the push-casting service platform 4 through the link address to obtain the corresponding resource information when the link address is received.

In the embodiment, the acoustic code pressing module 32 further includes a first acoustic wave receiving module, and a first acoustic wave DAC module. The first acoustic wave receiving module is configured to receive the acoustic signal sent by the acoustic code sending device 1. The first acoustic wave DAC module is configured to convert the acoustic signal to obtain the corresponding acoustic code by inverse fourier transformation.

In the embodiment, the relay base station 22 is further configured to process the acoustic signal to obtain the corresponding radio signal when the acoustic signals is received, and send the radio signal to another relay base station to send the radio signal to the mobile terminal in the preset range.

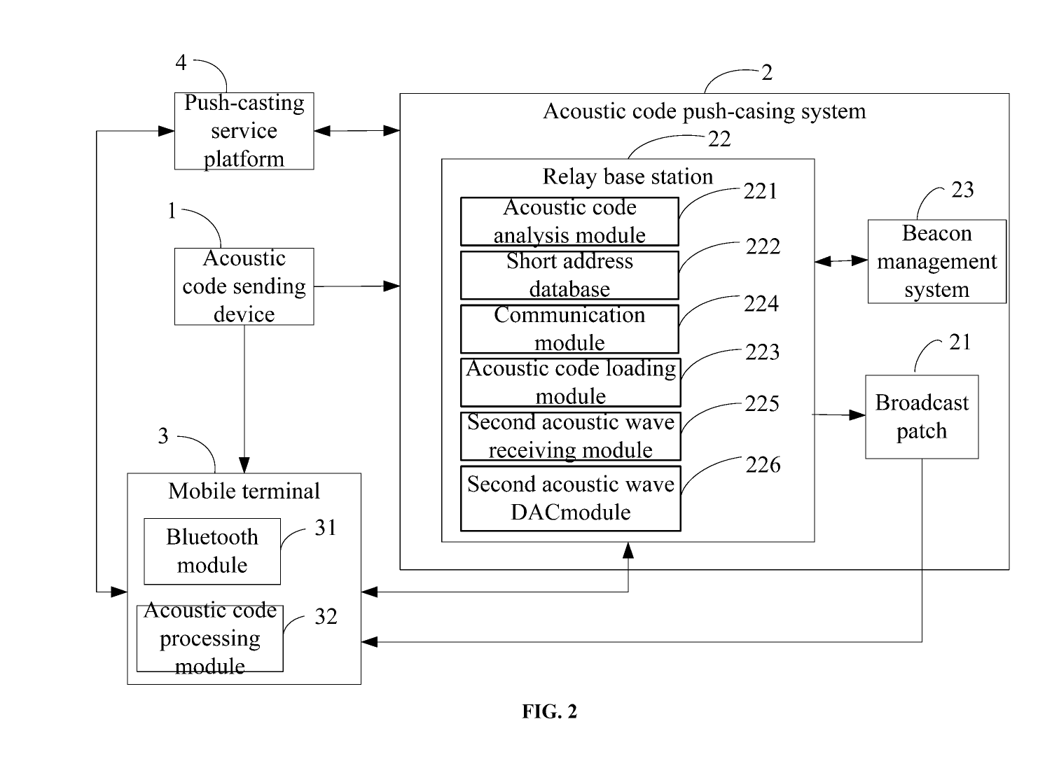

Referring to FIG. 2, in the embodiment, the acoustic code push-casting system 2 further includes a broadcast patch 21 communicating with the relay base station 22, and a beacon management system 23. The beacon management system 23 is configured to preset the relationship between acoustic codes and link addresses, set up and manage the broadcast patch 21 according to predefined rules.

The relay base station 22 further includes an acoustic code loading module 223, a second acoustic wave receiving module 225, and a second acoustic wave DAC module 226. The second acoustic wave receiving module 225 is configured to receive the acoustic signal sent by the acoustic code sending device 1. The second acoustic wave DAC module 226 is configured to convert the acoustic signal received by the second acoustic wave receiving module 225 to obtain the corresponding acoustic code by inverse fourier transformation, and send the acoustic code to the acoustic code loading module 223. The acoustic code loading module 223 is configured to obtain the acoustic code converted by the second acoustic wave DAC module 226, and embed the acoustic code into the beacon information format by beacon coding function to form beacon information containing the acoustic code and beacon code corresponding to the broadcast patch. The communication module 224 is configured to establish one-way communication with the broadcast patch 21 through bluetooth, and send the beacon information to the broadcast patch 21 corresponding to the beacon code in response to the instructions generated by the beacon management system 23. The instructions are generated according to the predefined rules by the beacon management system 23.

In the embodiment, the broadcast patch 21 is configured to receive the beacon information containing the acoustic code sent by the relay base station 22, and send the beacon information to the mobile terminal 3 which is in the preset range. The mobile terminal 3 is configured to process the beacon information to obtain the acoustic code by the acoustic code processing module 32 when the beacon information is received, and load the acoustic code to the relay base station 22.

In the embodiment, the information push-casting area is established corresponding to one or more merchants. Each information push-casting area includes at least one beacon management system, at least one relay base station, at least one acoustic code sending device and several broadcasting patches.

In the embodiment, the link address is URL or short address. The beacon management system 23 is BLE4.0 LAN management system. The push-casting service platform 4 includes a database for storing push-casting information content including acoustic codes as the main key content of the index table, short address bound to the acoustic codes, and information content corresponding to the short address. The information content corresponding to the short address includes one or more of the following: merchant type, merchant ID, product type, product ID, customer mobile phone number, geoLocation, coupon ID, coupon status, time stamp, advertisement, activities, and public service information.

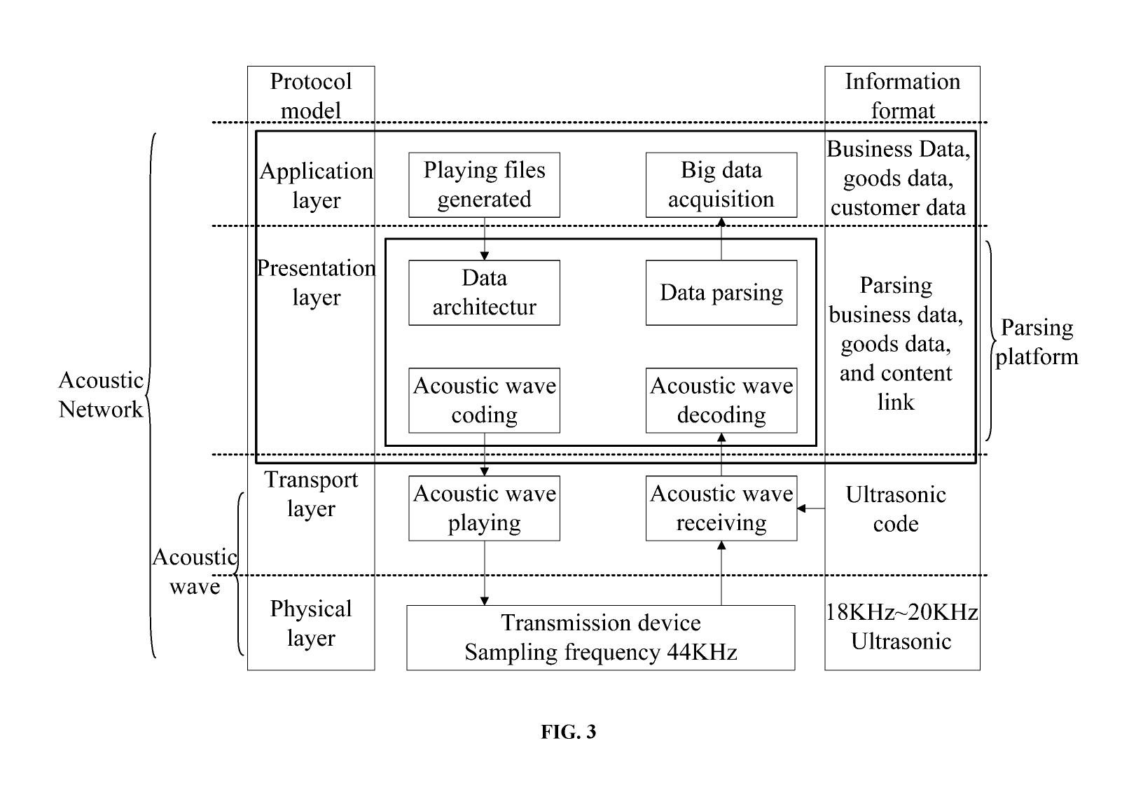

Referring to FIG. 3, in the embodiment, the protocol model for sending acoustic wave includes a physical layer, a transport layer, a presentation layer, and an application layer.

The physical layer is at the bottom of the protocol model, which provides acoustic transmission medium and interconnection equipment for data communication between devices, reliable transmission environment for data transmission, and hardware support for acoustic transmission. The physical layer mainly includes acoustic transmission equipment and acoustic receiving equipment. At the same time, the physical layer includes hardware requirements for transmitting and receiving devices, such as frequency range, sampling rate, intensity range, etc.

The transport layer is located on the physical layer for data transmission from the source to the destination, that is, the transmission equipment and media based on the physical layer, which sends acoustic waves from the acoustic transmission equipment to the acoustic receiving equipment. The transport layer supports for playing acoustic wave through the loudspeaker of the transmission end and receiving acoustic wave through the microphone of the receiving end. During the transmission process, the acoustic wave can be played repeatedly according to the actual application scene in order to improve the accuracy. The transport layer further puts forward nonnative requirements on intensity, time length and non-overlapping of the transmitted acoustic wave.

The presentation layer is configured to define a general data format for acoustic communication, and provides a standard encoding and decoding rule for converting data. The presentation layer supports for string construction and check code generation of pre-sending data, encoding and generation of acoustic signal, processing and decoding after signal received, string parsing and check code verification of data. The presentation layer is further configured to define general standard data construction, analysis rules, and acoustic code and decoding rules.

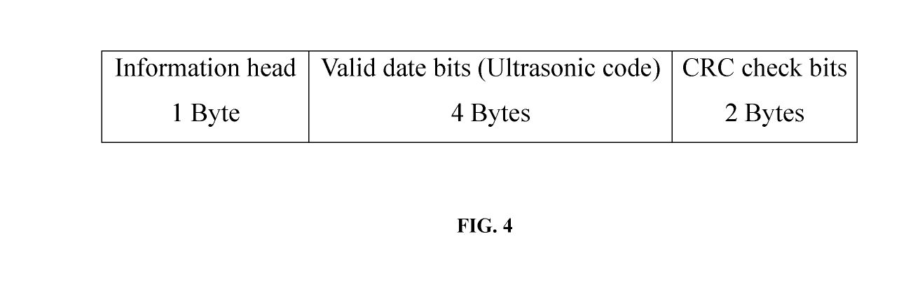

Referring to FIG. 4, before coding the string of data to be transmitted into the acoustic wave, the data structure needs to add information header and CRC check bits, in addition to the data content. A complete information segment includes the data content, the information header, and the CRC check bits, which consists of seven bytes. The first byte of the information segment is the information header, which can be used as a separator to locate the initial byte of the received acoustic wave during the cycle, as a group identification to distinguish different groups of acoustic waves, and as a secret protocol between the acoustic transmitter and the acoustic receiver. The 4 byte in the middle of the information segment is valid data bits, that is, the actual information transmitted, such as the acoustic code. The last 2 bytes are the CRC check bits to verify the correctness and completeness of the data transmitted by the ultrasonic code.

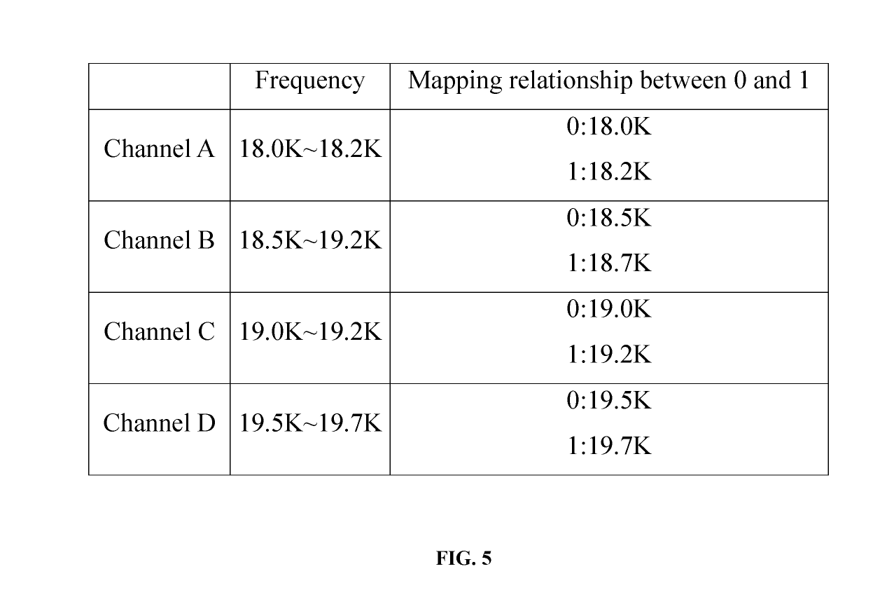

Referring to FIG. 5, in the embodiment, the bandwidth of the acoustic code information section is 18K-20K, which is divided into four channels. As shown in FIG. 5, the corresponding frequency ranges of channel A, channel B, channel C and channel D are set up, and the mapping relationship between them and the high and low level signals is established. A byte is used to represent a transmission sequence of the above four channels to form an information transmission sequence table. The byte is used as the information header to define the order of information transmission of four channels. For example, header A represents the order of information transmission, which is channel B, channel A, channel D and channel C. Header F represents the order of information transmission, which is channel A, channel C, channel D and channel B. The information transmission sequence table is stored in the acoustic transmitter and the acoustic receiver respectively to be called.

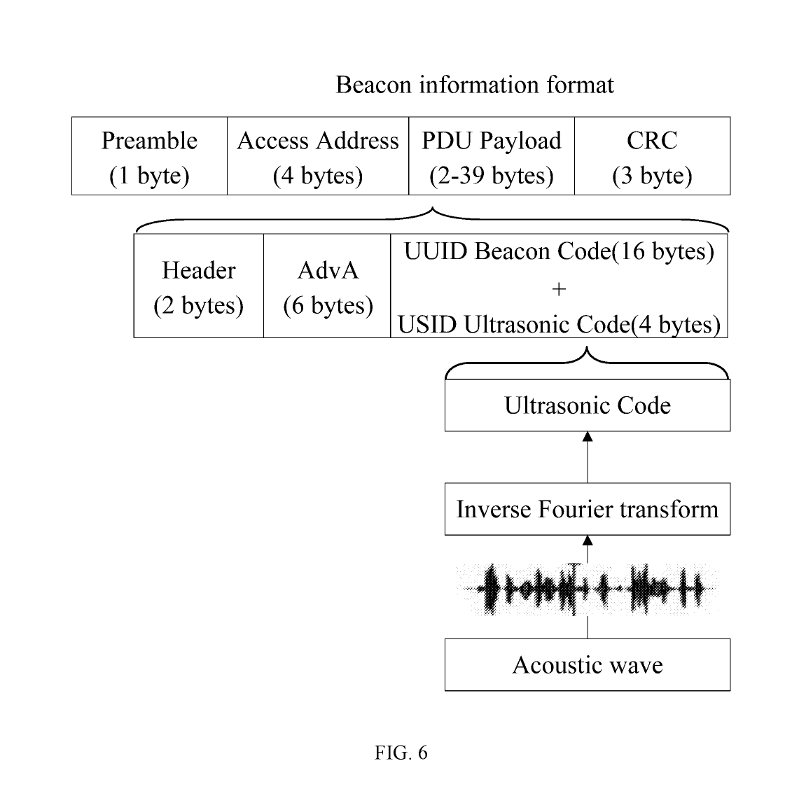

Referring to FIG. 6, in the embodiment, the merchant in the present invention plays audio and video documents containing the USID through the acoustic code sending device 1 in the information broadcasting area, or directly sends the acoustic signal converted by the USID. The second acoustic wave receiving module 225 of the relay base station 22 receives the acoustic signal sent by the acoustic code sending device 1. The second acoustic wave DAC module 226 converts the acoustic signal to obtain the USID by inverse fourier transform. The acoustic code loading module 223 embed the USID and UUID into the beacon information format by beacon encoder to form beacon information. The PDU (Protocol Data Unit) payload of the beacon information format includes four-bytes acoustic code and UUID, which are determined whether to transmit data information or location information by the different parameters of Access Address. The relay base station 22 sends the beacon information to the broadcast patch 21 corresponding to the UUID. The beacon broadcast patch 21 broadcasts the beacon information.

During acoustic communication, the acoustic wave is modulated to 18K-20K frequency, and further is decoded to obtain the corresponding acoustic code after FFT acoustic wave conversion. Embedding the acoustic code into the beacon information format can make the information transmission farther and more stable.

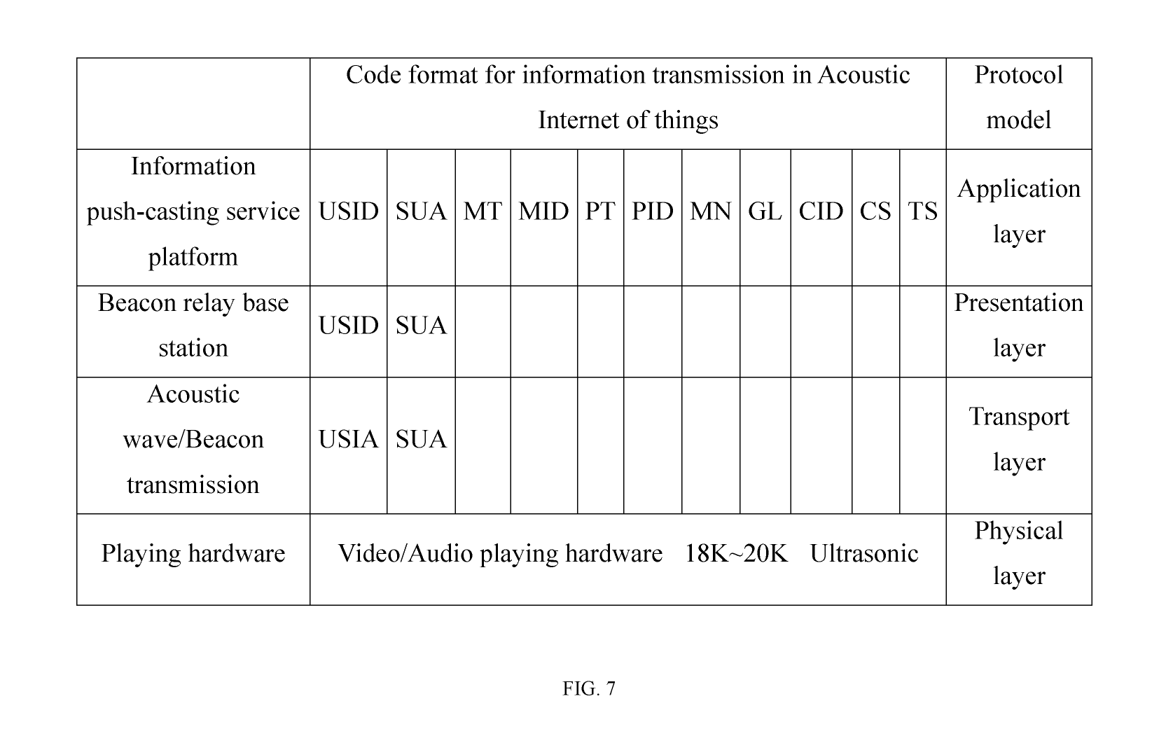

FIG. 7 shows a schematic diagram of data transmission information format of the acoustic Internet of things in accordance with an exemplary embodiment.

Ultrasonic ID(USID): acoustic code being embedded in acoustic waves or radio waves.

Short URL Address (SUA): configured to link to the information broadcasting service platform to obtain the corresponding information, and link to the Internet pages also. The information corresponding to the short address includes one or more of the following: merchant type, merchant ID, product type, product ID, customer mobile phone number, geoLocation, coupon ID, coupon status, time stamp, advertisement, activities, and public service information.

The information refers to audio, video, pictures, texts and web page.

Merchant Type(MT): configured to distinguish the type of merchants;

Merchant ID(MID): configured to identify merchants;

Product Type(PT): configured to distinguish the type of products;

Product ID(PID): configured to identify products;

Mobile No.(MN): configured to bind customer mobile phone number;

GeoLocation(GL): configured to record the location or GPS longitude and latitude of the beacon or the acoustic code sending device;

Coupon ID(CID): configured to record the use of coupons;

Coupon Status(CS): including used, unused or expired;

Time Stamp(TS): configured to record trading time;

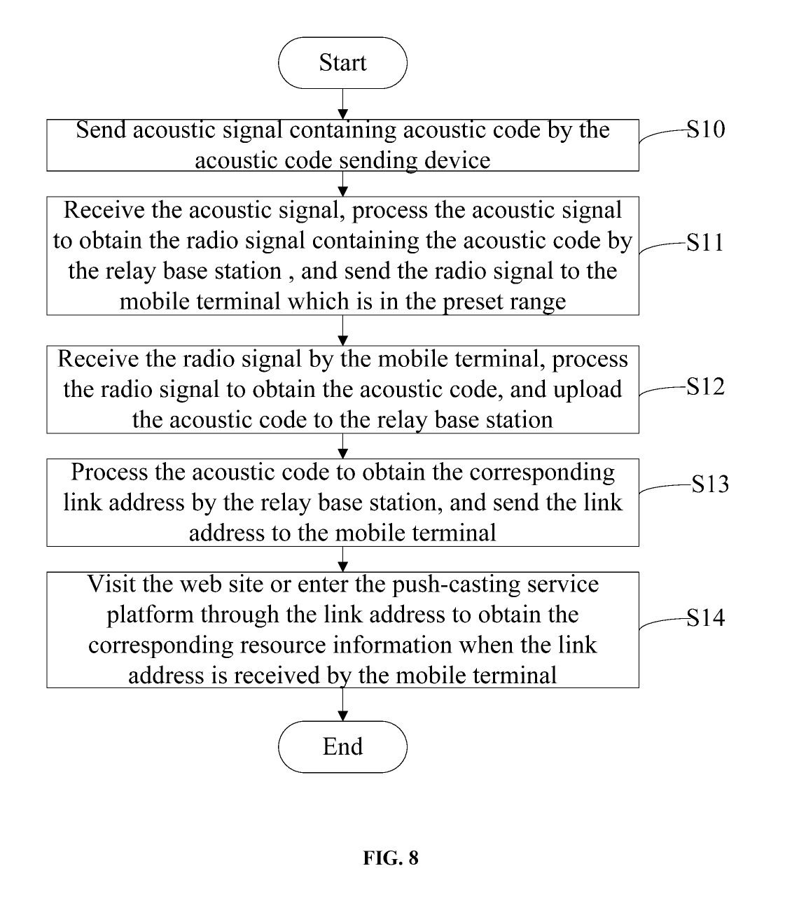

FIG. 8 shows a flowchart of a method for transmitting data via acoustic internet of things in accordance with a first exemplary embodiment.

In step S10, the acoustic code sending device 1 sends acoustic signal containing acoustic code.

In step S11, the relay base station 22 receives the acoustic signal, processes the acoustic signal to obtain the radio signal containing the acoustic code, and sends the radio signal to the mobile terminal 3 which is in the preset range.

In step S12, the mobile terminal 3 receives the radio signal, processes the radio signal to obtain the acoustic code, and uploads the acoustic code to the relay base station 22.

In step S13, the relay base station 22 processes the acoustic code to obtain the corresponding link address, and sends the link address to the mobile terminal 3. The relationship between acoustic codes and link addresses is pre-stored in the relay base station 22.

In step S14, the mobile terminal 3 visits the web site or enters the push-casting service platform 4 through the link address to obtain the corresponding resource information when the link address is received. Then, the process goes end.

The resource information corresponding to the acoustic codes and link addresses is pre-stored in the push-casting service platform 4.

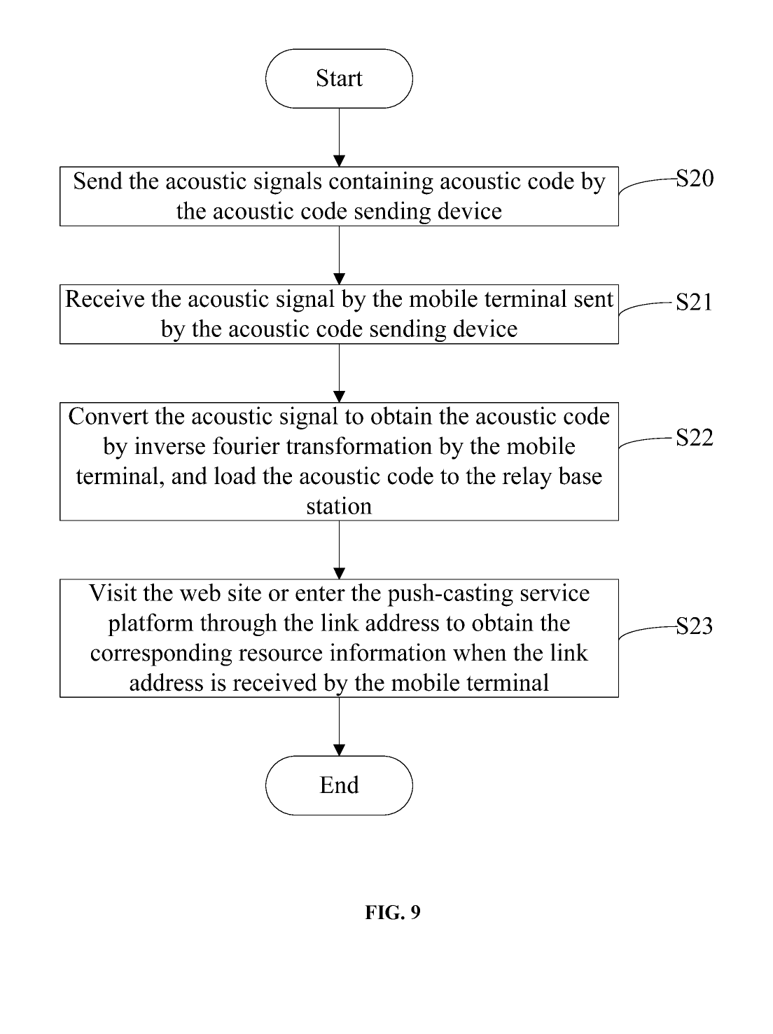

FIG. 9 shows a flowchart of a method for transmitting data via acoustic internet of things in accordance with a second exemplary embodiment.

In step S20, the acoustic code sending device 1 sends the acoustic signal containing acoustic code.

In step S21, the mobile terminal 3 receives the acoustic signal sent by the acoustic code sending device 1.

In step S22, the mobile terminal 3 converts the acoustic signal to obtain the acoustic code by inverse fourier transformation, and loads the acoustic code to the relay base station 22.

In step S23, the mobile terminal 3 visits the web site or enters the push-casting service platform 4 through the link address to obtain the corresponding resource information when the link address is received. Then, the process goes end.

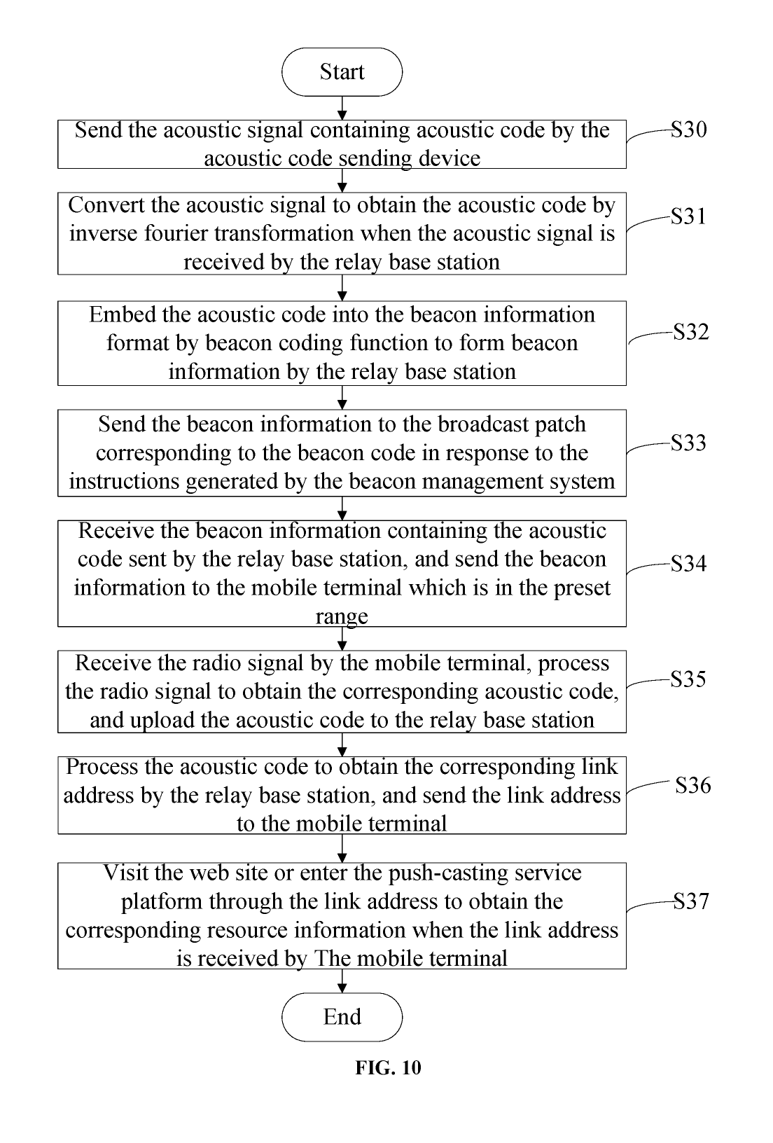

FIG. 10 shows a flowchart of a method for transmitting data via acoustic internet of things in accordance with a third exemplary embodiment.

In step S30, the acoustic code sending device 1 sends the acoustic signal containing acoustic code.

In step S31, the relay base station 22 converts the acoustic signal to obtain the acoustic code by inverse fourier transformation when the acoustic signal is received.

In step S32, the relay base station 22 embeds the acoustic code into the beacon information format by beacon coding function to form beacon information. The beacon information contains the acoustic code and beacon code corresponding to the broadcast patch.

In step S33, the relay base station 22 sends the beacon information to the broadcast patch 21 corresponding to the beacon code in in response to the instructions generated by the beacon management system 23. The instructions are generated according to the predefined rules by the beacon management system 23.

In step S34, the broadcast patch 21 receives the beacon information containing the acoustic code sent by the relay base station 22, and sends the beacon information to the mobile terminal 3 which is in the preset range. Then, the process goes to step S35.

In the embodiment, the resource information pre-stored in the push-casting service platform 4 comprises acoustic codes as the main key content of the index table, short address bound to the acoustic codes, and information corresponding to the short address including one or more of the following: merchant type, merchant ID, product type, product ID, customer mobile phone number, geoLocation, coupon ID, coupon status, time stamp, advertisement, activities, and public service information.

For example, the predefined rules by the beacon management system 23 is set that merchant A broadcasts product type B and coupon ID C during 12:00-14:00 every day. According to the predefined rules, the beacon information is sent to the broadcast patch corresponding to the beacon code, such as the broadcast patch in the area where the merchant A is located. When the user with mobile terminal is within a certain range during 12:00-14:00, the signal is obtained from the broadcast patch through the acoustic code processing module 32 of the mobile terminal 3, and the coupon ID C issued by the merchant code B is accessed according to the corresponding link address.

For example, the predefined rules by the beacon management system 23 is set that merchant A broadcasts product ID B and coupon ID C all day. According to the predefined rules, the beacon information is sent to each beacon broadcast patch. Users with mobile terminals can obtain signals from broadcast patches through the acoustic code processing module 32 at any location, and access the coupon ID C of product ID B issued by the merchant A according to the link address.

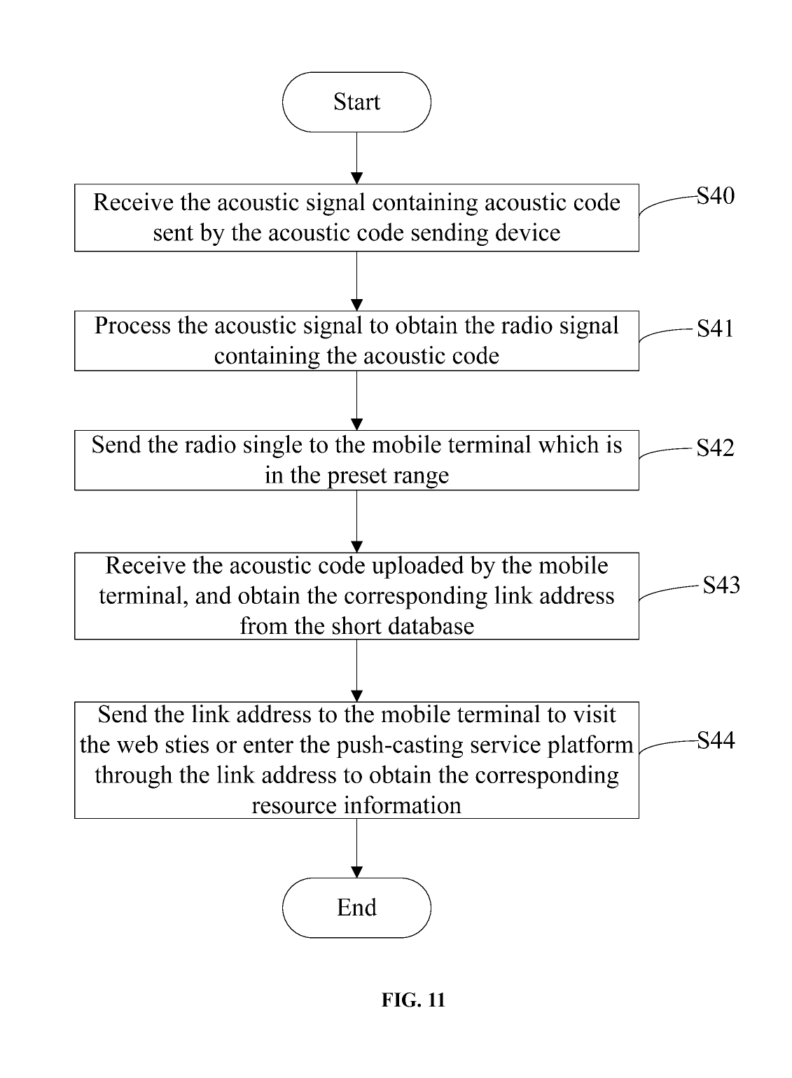

FIG. 11 shows a flowchart of a method for transmitting data via acoustic internet of things in accordance with a fourth exemplary embodiment.

In step S40, the relay base station 22 receives the acoustic signal containing acoustic code sent by the acoustic code sending device 1.

In step S41, the relay base station 22 processes the acoustic signal to obtain the radio signal containing the acoustic code.

In step S42, the relay base station 22 sends the radio single to the mobile terminal 3 which is in the preset range.

In step S43, the relay base station 22 receives the acoustic code uploaded by the mobile terminal 3, and obtains the corresponding link address from the short database.

In step S44, the relay base station 22 sends the link address to the mobile terminal 3 to visit the web site or enter the push-casting service platform 4 through the link address to obtain the corresponding resource information.

In the embodiment, the acoustic code uploaded by the mobile terminal 3 is obtained by processing the radio signal received by the mobile terminal 3. The resource information corresponding to the acoustic codes and the link addresses is pre-stored in the push-casting service platform 4.

In the embodiment, after processing the acoustic signal to obtain a radio signal containing the acoustic code, the relay base station 22 sends the radio signal to another relay base station.

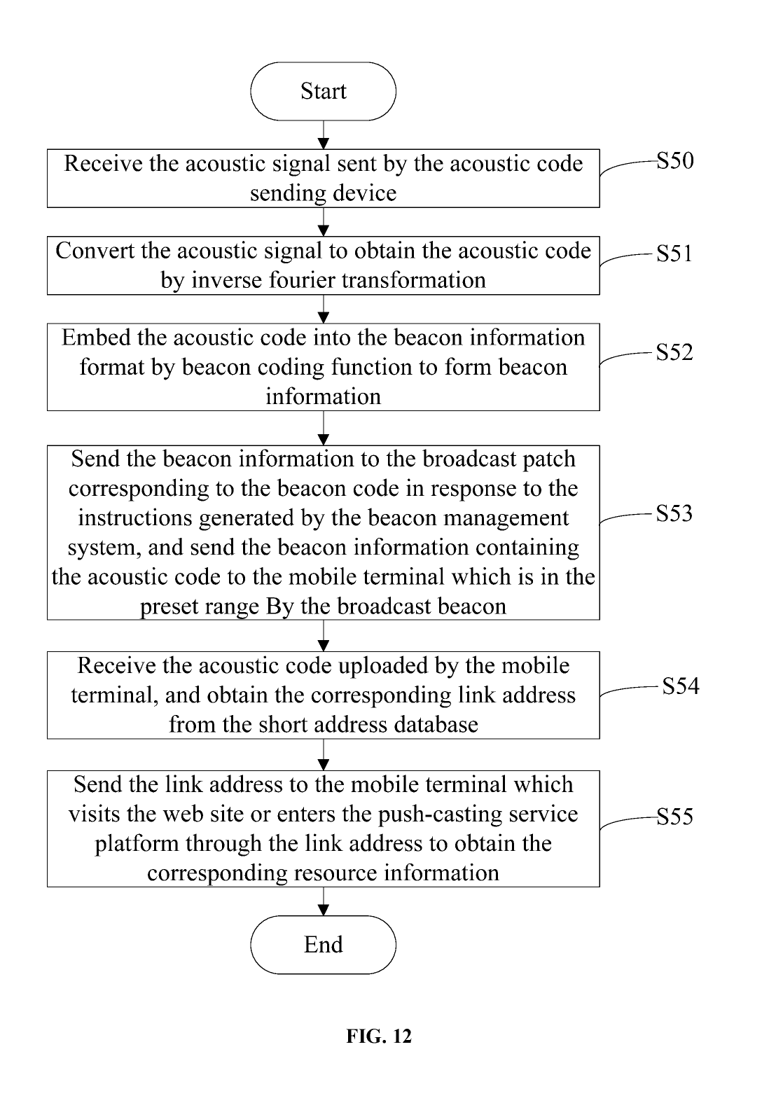

FIG. 12 shows a flowchart of a method for transmitting data via acoustic internet of things in accordance with a fifth exemplary embodiment.

In step S50, the relay base station 22 receives the acoustic signal sent by the acoustic code sending device 1.

In step S51, the relay base station 22 converts the acoustic signal to obtain the acoustic code by inverse fourier transformation.

In step S52, the relay base station 22 embeds the acoustic code into the beacon information format by beacon coding function to form beacon information. The beacon information contains the acoustic code and beacon code corresponding to the broadcast patch.

In step S53, the relay base station 22 sends the beacon information to the broadcast patch 21 corresponding to the beacon code in in response to the instructions generated by the beacon management system 23, and the broadcast patch 21 sends the beacon information containing the acoustic code to the mobile terminal 3 which is in the preset range. The instructions are generated according to the predefined rules by the beacon management system 23.

In step S54, the relay base station 22 receives the acoustic code uploaded by the mobile terminal 3, and obtains the corresponding link address from the short address database.

In step S55, the relay base station 22 sends the link address to the mobile terminal 3 which visits the web site or enters the push-casting service platform 4 through the link address to obtain the corresponding resource information.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A system for transmitting data via acoustic internet of things comprising an acoustic code sending device, an acoustic code push-casting system, a mobile terminal, and a push-casting service platform, wherein:
the acoustic code sending device configured to send acoustic signal containing acoustic code;
the acoustic code push-casting system comprises a relay base station, configured to receive the acoustic signal, process the acoustic signal to obtain radio signal containing the acoustic code, and send the radio signal to the mobile terminal which is in a present range;
the mobile terminal comprises an acoustic code processing module configured to process the radio signal to obtain the acoustic code, and load the acoustic code to the relay base station;
the relay base station further configured to obtain a corresponding link address according to the acoustic code loaded by the mobile terminal, and send the link address to the mobile terminal, wherein a relationship between acoustic codes and link addresses being pre-stored in the relay base station;
the acoustic code processing module further configured to visit a web site or enter the push-casting service platform through the link address to obtain the corresponding resource information when the link address is received, wherein the resource information corresponding to the acoustic code and the link address being pre-stored in the push-casting service platform.

2. The system as described in claim 1, wherein the relay base station comprising:
a communication module configured to communicate with the mobile terminal;
a short address database configured to pre-store the relationship between acoustic codes and link addresses, wherein the link address being short address;
an acoustic code analysis module configured to obtain the corresponding link address from the short address database according to the acoustic code loaded by the mobile terminal, and send the link address to the acoustic code processing module by the communication module.

3. The system as described in claim 1, wherein the acoustic code processing module comprising:
a first acoustic wave receiving module configured to receive the acoustic signal sent by the acoustic code sending device;
a first acoustic wave DAC module configured to convert the acoustic signal to obtain the corresponding acoustic code by inverse fourier transformation.

4. The system as described in claim 1, wherein the acoustic code push-casting system further comprising:
a broadcast patch communicating with the relay base station;
a beacon management system configured to preset the relationship between acoustic codes and link addresses, set up and manage the broadcast patch according to predefined rules;
the relay base station further comprising:
a second acoustic wave receiving module configured to receive the acoustic signal sent by the acoustic code sending device;
a second acoustic wave DAC module configured to convert the acoustic signal to the corresponding acoustic code by inverse fourier transformation;
an acoustic code loading module configured to obtain the acoustic code converted by the second acoustic wave DAC module, and embed the acoustic code into the beacon information format by beacon coding function to form beacon information containing the acoustic code and beacon code corresponding to the broadcast patch;
a communication module configured to establish one-way communication with the broadcast patch through bluetooth, and send the beacon information to the broadcast patch corresponding to the beacon code in response to the instructions generated by the beacon management system, wherein the instructions being generated according to the predefined rules by the beacon management system;
the broadcast patch further configured to receive the beacon information containing the acoustic code sent by the relay base station, and send the beacon information to the mobile terminal which is in the preset range.

5. The system as described in claim 1, wherein the relay base station is further configured to send the radio signal to another relay base station, the another relay base station is configured to send the radio signal to the mobile terminal which in the preset range.

6. The system as described in claim 1, wherein the mobile terminal is further configured to pre-store the relationship between acoustic codes and link addresses, which is preset by the acoustic code processing module, or downloaded from the relay base station;
the acoustic processing module is further configured to obtain the acoustic code from the radio signal when it is received, and obtain the corresponding link address according to the relationship pre-stored in.

7. The system as described in claim 1, wherein the beacon management system is BLE4.0 LAN management system.

8. The system as described in claim 1, wherein the resource information pre-stored in the push-casting service platform comprises acoustic codes as the main key content of the index table, short address bound to the acoustic codes, and information content corresponding to the short address including one or more of the following: merchant type, merchant ID, product type, product ID, customer mobile phone number, geoLocation, coupon ID, coupon status, time stamp, advertisement, activities, and public service information.

9. A relay base station comprising:
a short address database configured to pre-stored a relationship between acoustic codes and link addresses, wherein the link address being short address;
a receiving module configured to receive an acoustic signal containing acoustic code, and process the acoustic signal to obtain a radio signal containing the acoustic code;
a communicating module configured to send the radio signal to a mobile terminal which is in a preset range; and
an acoustic analysis module configured to obtain a corresponding link address from the short address database according to the acoustic code loaded by the mobile terminal, and send the link address to the mobile terminal to visit a web sites or enter a push-casting service platform through the link address to obtain the corresponding resource information; wherein the acoustic code loaded by the mobile terminal being obtained from the radio signal received, and the resource information corresponding to the acoustic code and the link address being pre-stored in the push-casting service platform.

10. The relay base station as described in claim 9, further comprising:
a second acoustic wave DAC module configured to convert the acoustic signal to obtain the corresponding acoustic code by inverse fourier transformation;
an acoustic code loading module configured to obtain the acoustic code converted by the second acoustic wave DAC module, and embed the acoustic code into the beacon information format by beacon coding function to form beacon information containing the acoustic code and beacon code corresponding to broadcast patch;
the communication module further configured to establish one-way communication with the broadcast patch through bluetooth, and send the beacon information to the broadcast patch corresponding to the beacon code in response to the instructions generated by a beacon management system, that the broadcast patch sends the beacon information to the mobile terminal which is in the preset range; wherein the instructions being generating according to predefined rules by the beacon management system.

11. The relay base station described in claim 9, wherein the communication module is further configured to send the radio signal to another relay base station.

12. A method for transmitting data via acoustic internet of things comprising:
sending acoustic signal containing acoustic code by an acoustic code sending device;
receiving the acoustic signal by a relay base station, processing the acoustic signal to obtain radio signal containing the acoustic code, and sending the radio signal to a mobile terminal which is in preset range;
processing the radio signal to obtain the acoustic code by the mobile terminal, and loading the acoustic code to the relay base station;
obtaining a corresponding link address according to the acoustic code loaded by the mobile terminal, and sending the link address to the mobile terminal, wherein a relationship between acoustic codes and link addresses being pre-stored in the relay base station;
visiting a web site or entering a push-casting service platform through the link address to obtain the corresponding resource information when the link address is received by the mobile terminal, wherein the resource information corresponding to the acoustic code and the link address being pre-stored in the push-casting service platform.

13. The method as described in claim 12, further comprising:
receiving the acoustic signal containing the acoustic code by the mobile terminal sent by the acoustic code sending device;
converting the acoustic signal to the acoustic code by inverse fourier transformation by the mobile terminal, and loading the acoustic code to the relay base station.

14. The method as described in claim 12, wherein after sending acoustic signal containing acoustic code by an acoustic code sending device, further comprising:
receiving the acoustic signal by the relay base station, and converting the acoustic signal to the acoustic code by inverse fourier transformation;
embedding the acoustic code into a beacon information format by beacon coding function to form beacon information containing the acoustic code and the beacon code corresponding to a broadcast patch;
sending the beacon information to the broadcast patch corresponding to the beacon code in response to the instructions generated by a beacon management system, wherein the instructions being generated according to the predefined rules by the beacon management system;
receiving the beacon information containing the acoustic code sent by the relay base station by the broadcast patch, and sending the beacon information to the mobile terminal which is in the preset range.

15. The method as described in claim 12, wherein after processing the radio signal to obtain the acoustic code by the mobile terminal, further comprising:
obtaining the corresponding link address according to the relationship between acoustic codes and link addresses pre-stored in and preset by the mobile terminal or downloaded from the relay base station.

16. The method as described in claim 12, wherein the resource information pre-stored in the push-casting service platform comprises acoustic codes as the main key content of the index table, short address bound to the acoustic codes, and information content corresponding to the short address including one or more of the following: merchant type, merchant ID, product type, product ID, customer mobile phone number, geoLocation, coupon ID, coupon status, time stamp, advertisement, activities, and public service information.

17. A method for transmitting data via acoustic internet of things comprising:
receiving an acoustic signal containing acoustic code sent by an acoustic code sending device;
processing the acoustic signal to obtain a radio signal containing the acoustic code;
sending the radio signal to a mobile terminal which is in a preset range;
obtaining a corresponding link address from a short address database according to the acoustic code loaded by the mobile terminal, and obtained from the radio signal by the mobile terminal;
sending the link address to the mobile terminal to visit a web site or enter a push-casting service platform through the link address to obtain the corresponding resource information, wherein the resource information corresponding to the link address and acoustic code being pre-stored in the push-casting service platform.

18. The method as described in claim 17, wherein after receiving an acoustic signal containing acoustic code sent by an acoustic code sending device, further comprising:
converting the acoustic signal to the acoustic code by inverse fourier transformation;
embedding the acoustic code into a beacon information format by beacon coding function to form beacon information containing the acoustic code and the beacon code corresponding to a broadcast patch;
sending the beacon information to the broadcast patch corresponding to the beacon code in response to the instructions generated by a beacon management system, wherein the instructions being generated according to the predefined rules by the beacon management system.

19. The method as described in claim 17, wherein after processing the acoustic signal to obtain a radio signal containing the acoustic code, further comprising: sending the radio signal to another relay base station.
